(19) United States
(12) Patent Application Publication
(10) Pub. No.: US 2010/0092735 A1
(43) Pub. Date: Apr. 15, 2010

(54) Masking media for heat activated graphics

(75) Inventors: Witold S. Perlinski, Middlesex, NJ (US); Philip J. Iwinski, Nazareth, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: R Tape Corporation

(21) Appl. No.: 12/287,854

(22) Filed: Oct. 14, 2008

(51) Int. Cl. B32B 7/06; B32B 27/08; B32B 27/36; B32B 27/30; B32B 37/26; B05D 1/00; D06Q 1/12; B05D 5/10; B05D 5/08

(52) U.S. Cl. 428/187; 428/349; 427/148; 156/324; 156/244.11; 156/267; 156/231; 428/345

(57) ABSTRACT

The present invention provides a masking media for heat activated graphics. The masking media includes a film having a first release surface, an opposite. treated surface, and a two-part adhesive applied to the treated surface. The adhesive is adapted to secure graphics to the film to enable the graphics to be hot-pressed onto a fabric substrate. The adhesive includes acrylic and isocyanate in a ratio of isocyanate to acrylic of at least about 1.1%. The media can be wound upon itself with the adhesive contacting the release surface and subsequently being unwound with the adhesive releasing from the release surface.

### FIELD OF INVENTION

The present invention relates generally to a masking media for applying heat activated graphics to a fabric substrate and specifically to a masking media that can be wound upon itself without need of a protective liner.

### BACKGROUND OF INVENTION

Conventional masking media for applying heat activated graphics to a fabric substrate utilize an adhesive on one side of a flexible carrier film for securing the graphics in a desired position on the film. After the graphics are applied to the substrate, the carrier film is removed. The ease with which the carrier film can be removed depends on the tack (and corresponding peel adhesion strength) of the adhesive. Adhesives currently used in the art typically are two-part solvent based adhesives combining acrylic with a small percentage of isocyanate. For example, the masking media disclosed in U.S. Pat. No. 6,613,412 uses compositions having isocyanate to acrylic ratios of less than 1%. Specifically, a low tack composition of 0.3% isocyanate to acrylic solids is described as having a room temperature peel adhesion strength of 4 to 8 oz/in, and a high tack composition of 0.4% to 0.8% isocyanate to acrylic solids having a room temperature peel adhesion strength of 8 to 20 oz/in. (Although U.S. Pat. No. 6,613,412 refers to the peel adhesion strength in units of oz/in², note that the correct units for peel adhesion strength are oz/in or ounces per inch.) Removal of the carrier film in U.S. Pat. No. 6,613,412 is done while the film is still hot.

Typically, the masking media is manufactured with a protective release coated liner and then wound upon itself for storage and/or shipment. After unwinding the media, the released coated layer is removed to expose the adhesive, and a layer of graphics film is applied to the adhesive. The protective liner applied to the adhesive-coated side of the carrier film serves no other purpose than to enable the media to be wound and readily unwound.

The drawbacks of using a protective liner are evident. The protective liner adds extra material, size, and weight to a roll of masking media, which increases costs of both manufacture and shipping, and decreases the quantity of media that can be shipped in a single cargo load. Additionally, an extra manufacturing step is required to apply the protective liner to the adhesive on the carrier film, and a further extra manufacturing step is required to remove the protective liner from the adhesive on the carrier film before the layer of graphics film can be applied.

### SUMMARY OF INVENTION

In one embodiment, the present invention provides a masking media for heat activated graphics. The masking media includes a film having a first release surface, an opposite treated surface, and a two-part adhesive applied to the treated surface. The adhesive is adapted to secure graphics to the film to enable the graphics to be hot-pressed onto a fabric substrate. The adhesive comprises acrylic and isocyanate in a ratio of isocyanate to acrylic of at least about 1.1%. The media can be wound upon itself with the adhesive contacting the release surface and subsequently unwound with the adhesive releasing from the release surface.

In another embodiment, the present invention provides a method of making a masking media for heat activated graphics. The method includes providing a polyester carrier film, treating a first surface of the carrier film, applying a water-based adhesive to the treated surface of the carrier film, the adhesive comprising acrylic and isocyanate in a ratio of isocyanate to acrylic of at least about 1.1%, and drying the adhesive to form a masking media adapted to be self wound.

In yet another embodiment, the present invention provides a method of applying heat activated graphics to a fabric substrate. The method includes providing a polyester carrier film having a first release surface, an opposite treated surface, and a water-based adhesive applied to the treated surface, the carrier film being wound upon itself with the adhesive contacting the release surface. The method further includes unwinding the carrier film with the adhesive releasing from the release surface, laminating a graphics film to the carrier film, cutting graphics in the graphics film, weeding excess material from the graphics film; and hot pressing the graphics onto the fabric substrate. The graphics film includes a coextruded layer of heat activated adhesive facing away from the carrier film to adhere the graphics to the substrate. The adhesive comprises acrylic and isocyanate in a ratio of isocyanate to acrylic of at least about 1.1%.

Other objects, advantages, and features of the present invention will become apparent to those skilled in the art upon reading the following detailed description, when considered in conjunction with the appended claims and the accompanying drawings briefly described below.

### BRIEF DESCRIPTION OF DRAWINGS

The accompanying drawings, which are incorporated herein and constitute a part of this specification, illustrate preferred embodiments of the invention, and together with the general description given above and the detailed description given below, serve to explain features of the invention. However, it should be understood that this invention is not limited to the precise arrangements and instrumentalities shown in the drawings.

FIG. 1 cross-sectional view of an embodiment of a masking media for heat activated graphics in an unwound configuration.

FIG. 2 is a cross-sectional view of an embodiment of a masking media for heat activated graphics in a wound configuration.

FIG. 3 is a schematic of a process for coating and drying a carrier film for use in forming an embodiment of a masking media for heat activated graphics.

FIG. 4 is a schematic of a process for laminating graphics to a carrier film to form an embodiment of a masking media for heat activated graphics.

FIG. 5 is a schematic of a process for applying graphics to a substrate using an embodiment of a masking media for heat activated graphics.

### DETAILED DESCRIPTION OF THE ILLUSTRATED EMBODIMENTS

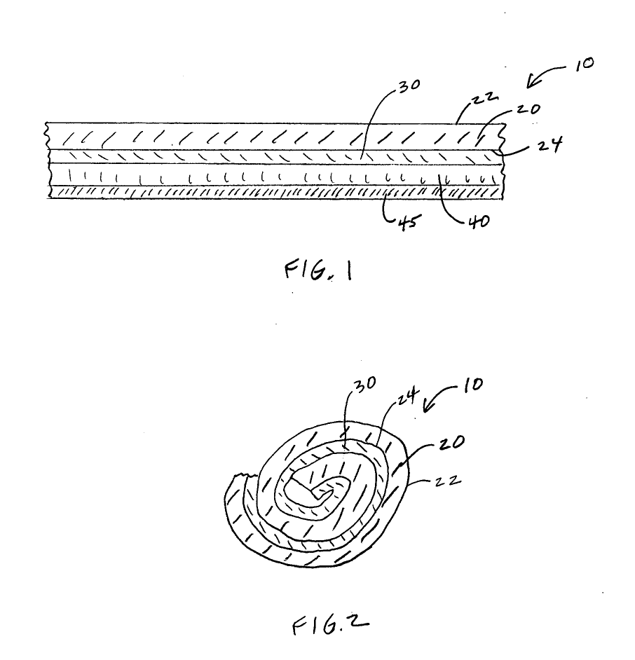

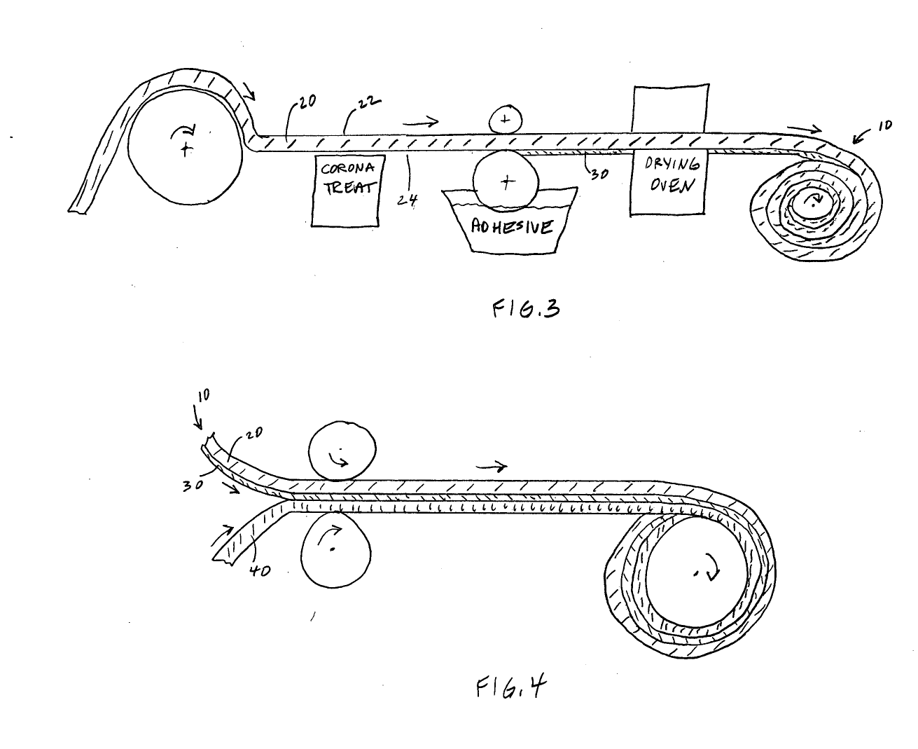

The present invention provides a masking media 10 for use in applying heat activated graphics to a fabric substrate. In the embodiment depicted in FIG. 1, the media 10 comprises a film 20 having a first release surface 22, an opposite treated surface 24, and a catalyzed adhesive 30 contacting the treated surface 24. The media 10 can be wound upon itself for storage, as depicted in FIG. 2, and subsequently unwound for use, without the need for a protective liner.

The media 10 is designed to be used with a graphics film 40 applied to the catalyzed adhesive 30 with the opposite side of the graphics film 40 containing a layer of heat activated adhesive 45 that is coextruded with or applied to the graphics film 40. Graphics films such as Thermoflex Plus® and ThermoFlex Sport®, sold by Specialty Materials of Tulsa, Okla., or ThermoFilm®, sold by Stahl's Inc. of St. Clair Shores, Mich., can be used. Graphics can be prepared from the graphics film by cutting through the heat activated adhesive layer 45 and the graphics film 40 in a desired graphics pattern and by then weeding (i.e., removing) portions of the graphics film 40 and adhesive layer 45 to reveal the graphics that will ultimately be applied to a fabric substrate 50. The graphics are then applied to the substrate 50 by hot pressing the media 10 against the substrate 50, as depicted in FIG. 5.

The film 20 is preferably a polyester film with a thickness of about 1 mil to about 10 mils, more preferably about 2 mils to about 7 mils, and still more preferably about 3 mils. Other equivalent thin flexible film materials capable of withstanding the heat required to apply graphics to a fabric substrate 50 can be used. The release surface 22 can be coated with a silicone release agent or a non-silicone release agent to facilitate release of the release surface 22 from the catalyzed adhesive 30 when the media 10 is wound upon itself and subsequently unwound, without the need for a protective liner to prevent the adhesive 30 from adhering to the release surface 22. Also, the release surface 22 can be either flat or embossed. Embossing the carrier film release surface 22 causes the surface 22 to act as a release surface and may be substituted for a release coating. Embossing acts as a mechanical release by virtue of minimizing the adhesive contact to the release surface. Because of the characteristics of the adhesive 30 in combination with the release surface 22, the adhesive does not adhere to the release surface 22 and thus does not inhibit the media in being transformed from a wound state to an unwound state.

The catalyzed adhesive 30 is preferably a water-based adhesive. In one embodiment, the adhesive 30 is a two-part adhesive comprising a hydroxyl-containing acrylic that is cured by a reaction with a water dispersible isocyanate. In one embodiment the acrylic is Acronal V210 acrylic base, sold by BASF, and the isocyanate comprises BAYHYDUR XP 7165 water dispersible isocyanate, sold by Bayer Material Science. The water-based adhesive can be applied to a dry adhesive thicknesses ranging from about 0.5 mil to about 5 mils, and preferably about 1 mil.

In testing, a peel value was established to measure the force required to weed graphics material from an adhesive coated carrier film after various dwell times. A composition as used in the present invention was compared with a prior art composition from Stahl's that uses a solvent-based adhesive having a lower isocyanate to acrylic ratio and thus different tack characteristics. The peel value was measured in units of grams per lineal inch (gli) of peel. (Grams per lineal inch (gli) is a measure of the force required to coated peel a 1 inch wide sample 180 degrees to the direction of peel at a crosshead speed of 12 feet per minute.) After a dwell time of 5 minutes, the presently disclosed adhesive composition required 60 gli to peel while the prior art composition required 107 gli. After a dwell time of 1 hour, the present adhesive composition required 80 gli to peel while the prior art composition required 144 gli. After a dwell time of 24 hours, the present adhesive composition required 128 gli to peel while the prior art composition required 205 gli. In addition, workers employed to perform the weeding tack noted the difference in the ease of removal of unwanted graphics, and fewer repetitive stress injuries were reported.

Prior to applying the adhesive 30, the surface 24 of the film can be chemically or corona treated. The chemical treatment or corona treatment of the treated surface 24 enables the adhesive 30 to adhere sufficiently to the film 20 so as to retain graphics for placement on a fabric substrate 50 while further enabling weeding of the graphics and removal of the media 10 from the graphics after the graphics are hot-pressed onto the fabric substrate 50.

An embodiment of the media 10 can be prepared as depicted schematically in FIG. 3. A surface of a polyester film 20 is subjected to a corona treatment to create a treated surface 24. An opposite surface of the film 20 is coated or treated with a release agent to create a release surface 22. A water-based adhesive 30 is applied to the treated surface 24 and the adhesive 30 is dried in a drying oven. The media 10 is optionally wound for storage without a protective liner. A protective liner is not necessary because the release surface 22 is readily releasable from the adhesive 30.

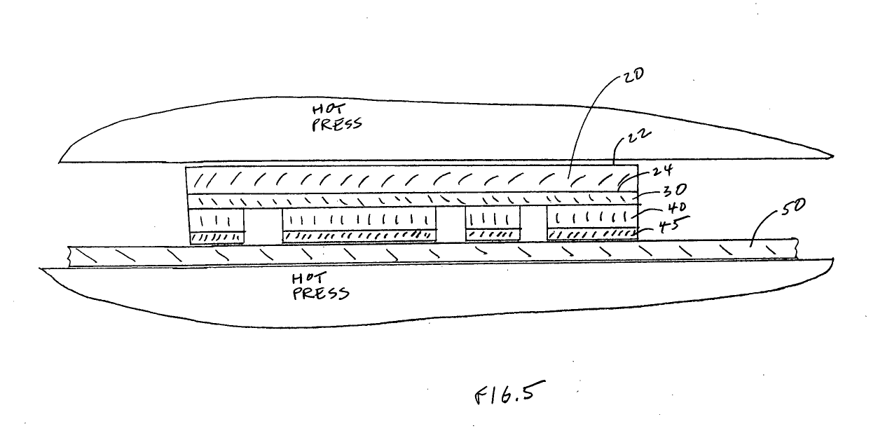

A graphics film 40 can be laminated to the media 10 as depicted schematically in FIG. 4. The media 10 is unrolled or otherwise provided in an unrolled state in parallel with the graphics film 40. The media 10 and the graphics film 40 are laminated to each other by a nip roll that compresses the two films 10 and 40 together. The laminated combination of the media 10 with the graphics film 40 is optionally wound for storage. A layer of heat activated adhesive 45 is coextruded with the graphics film 40, the adhesive 45 being deposited on a side of the graphics film 40 opposite the media 10. Alternatively, a layer of heat activated adhesive 45 can be applied to the graphics film 40 after the graphics film 40 is laminated to the media 10.

The graphics film 40 preferably comprises a film of flexible polyurethane, PVC, or synthetic paper. The graphics film 40 is most preferably a polyurethane film such as BF Goodrich Tuftane 312 or Tuftane 322. The graphics film 40 can either be coextruded with a polyester or polyurethane heat activated adhesive such as Bostik 4117 polyester extrusion polymer, or coated with a heat activated hot melt adhesive such as Bostik 4103. After the graphics film 40 is laminated to the media 10, a desired graphics pattern, which can include letters, numbers, emblems, images, or any other graphics, is plotter cut to reveal the desired pattern. Plotter cutting cuts through the graphics film 40 and the heat activated adhesive layer 45, but not through the film 20, and preferably not through the adhesive 30. Subsequent to plotter cutting, excess graphics film 40 (i.e., that portion of the graphics film 40 not part of the desired graphics pattern to be transferred to the substrate 50) is removed or weeded away from the media 10. The residual graphics pattern remains positioned as desired on the media 10 and ready for transfer.

To transfer the graphics pattern onto a substrate 50, the media 10 with the remaining portion of the graphics film 40 is hot pressed onto the substrate 50, as depicted in FIG. 5. Hot pressing is preferably preformed in a clam press and is preferably done at a temperature in a range of about 200° F. to about 375° F. for a duration of time in a range of about 5 seconds to about 100 seconds. The heat activated adhesive 45 is activated during hot pressing to bond the graphics to the substrate 50. The masking media 10 protects the flexible graphics from heat distortion during the hot pressing process.

After hot pressing, the media 10 can be easily removed hot or cold, depending on the composition of the catalyzed adhesive 30. In particular, when a two-part adhesive is used having a hydroxyl-containing acrylic that is cured by a reaction with a water-dispersible isocyanate, the ratio of isocyanate to acrylic can be adjusted to control the adhesive tack and cure rate. Hot removal is possible at a wide range of isocyanate to acrylic ratios while cold removal requires higher relative amounts of isocyanate.

Specifically, the masking media 10 can be prepared with different levels of tack based on the ratio isocyanate to acrylic solids. A high tack media can be made using a ratio of about 1.1% to about 1.8% isocyanate to acrylic solids, a medium tack masking media can be made using a ratio of about 2.5% to about 3.5% isocyanate to acrylic solids, and a low tack masking media can be made using a ratio of more than about 3.5% up to about 6% isocyanate to acrylic solids. The corresponding peel adhesion strengths for the above compositions are high tack in the range of about 18 to about 20 ounces per inch (oz/in), medium tack in the range of about 14 to about 16 oz/in, and low tack in the range of about 5 to about 6 oz/in. The low and medium tack versions can be removed either hot or cold, whereas the high tack version requires hot removal. (Note that between about 1.8% and about 2.5% isocyanate to acrylic solids ratio, the adhesive will have a medium to high tack with peel strengths in between those listed herein.) While the low, medium, and high tack versions of the media display different peel adhesion strengths at approximately room temperature (i.e., between about 60° F. and about 90° F.), all compositions have a peel adhesion strength of less than about 3 oz/in at temperatures at which the carrier film 20 would be hot peeled from the graphics 40 (i.e., greater than about 200° F.).

The masking media 10 is adapted to be self wound, meaning that it can be wound upon itself and unwound without the need for a protective liner to prevent adherence of the catalyzed adhesive 30 to the release surface 22. Therefore, when using an embodiment of the masking media 10, the graphics film 40 can be directly laminated onto the media 10 without the extra step of removing a protective liner prior to lamination. The properties of the catalyzed adhesive 30 can be modified by varying the amount of catalyst (e.g., isocyanate when an amount of acrylic adhesive is used) to improve winding and unwinding of the media 10 and to improve the ease of removability of the media 10, either under hot conditions or under cooled down conditions, after the graphics have been hot pressed onto a substrate 50.

While the invention has been disclosed with reference to certain preferred embodiments, numerous modifications, alterations, and changes to the described embodiments are possible without departing from the sphere and scope of the invention, as defined in the appended claims and equivalents thereof. Accordingly, it is intended that the invention not be limited to the described embodiments, but that it have the full scope defined by the language of the following claims.

We claim:

1. A masking media for heat activated graphics, comprising:
a film having a first release surface and an opposite treated surface; and
a two-part adhesive applied to the treated surface, the adhesive comprising acrylic and isocyanate in a ratio of isocyanate to acrylic of at least about 1.1%, the adhesive being adapted to secure graphics to the film to enable the graphics to be hot-pressed onto a fabric substrate, the adhesive further being adapted to enable the film to be readily removed from the graphics after hot pressing;
wherein the media can be wound upon itself with the adhesive contacting the release surface and subsequently unwound with the adhesive releasing from the release surface.

2. The masking media of claim 1, wherein the adhesive is a water-based adhesive.

3. The masking media of claim 1, wherein the ratio of isocyanate to acrylic is between about 1.1% and about 1.8% and the adhesive has a room temperature peel adhesion strength of about 18 oz/in to about 20 oz/in.

4. The masking media of claim 1, wherein the ratio of isocyanate to acrylic is between about 2.5% and about 3.5% and the adhesive has a room temperature peel adhesion strength of about 14 oz/in to about 16 oz/in.

5. The masking media of claim 1, wherein the ratio of isocyanate to acrylic is between about 3.5% and about 6% and the adhesive has a room temperature peel adhesion strength of about 5 oz/in to about 6 oz/in.

6. The masking media of claim 1, wherein the film is a polyester film.

7. The masking media of claim 1, wherein the treated surface is chemically treated.

8. The masking media of claim 1, wherein the treated surface is corona treated.

9. The masking media of claim 1, wherein the release surface is coated with a silicone release agent.

10. The masking media of claim 1, wherein the release surface is coated with a non-silicone release agent.

11. The masking media of claim 1, wherein the release surface is flat.

12. The masking media of claim 1, wherein the release surface is embossed.

13. The masking media of claim 1, wherein the adhesive is adapted to release the graphics from the media immediately after the hot press cycle while the media is still hot.

14. The masking media of claim 11, wherein the adhesive is adapted to release the graphics from the media after the hot press cycle followed by a cooling down period.

15. A method of making a masking media for heat activated graphics, comprising:
providing a polyester carrier film;
treating a first surface of the carrier film;
applying a water-based catalyzed adhesive to the treated surface of the carrier film, the adhesive comprising acrylic and isocyanate in a ratio of isocyanate to acrylic of at least about 1.1%; and
drying the adhesive to form a masking media adapted to be self wound.

16. The method of making a masking media of claim 15, further comprising laminating a graphics film to the carrier film.

17. The method of making a masking media of claim 16, wherein the graphics film is coextruded with a heat activated adhesive layer.

18. The method of making a masking media of claim 16, further comprising cutting graphics in the graphics film and weeding excess material from the graphics film.

19. The method of making a masking media of claim 15, further comprising applying a release agent to a second surface of the carrier film, the second surface being opposite the first surface.

20. The masking media of claim 15, wherein the ratio of isocyanate to acrylic is between about 1.1% and about 1.8% and the adhesive has a room temperature peel adhesion strength of about 18 oz/in to about 20 oz/in.

21. The masking media of claim 15, wherein the ratio of isocyanate to acrylic is between about 2.5% and about 3.5% and the adhesive has a room temperature peel adhesion strength of about 14 oz/in to about 16 oz/in.

22. The masking media of claim 15, wherein the ratio of isocyanate to acrylic is between about 3.5% and about 6% and the adhesive has a room temperature peel adhesion strength of about 5 oz/in to about 6 oz/in.

23. The masking media of claim 15, wherein treating a first surface of the carrier film includes chemical treatment.

24. The masking media of claim 15, wherein treating a first surface of the carrier film includes corona treatment.

25. A method of applying heat activated graphics to a fabric substrate, the method comprising:
providing a polyester carrier film having a first release surface, an opposite treated surface, and a water-based catalyzed adhesive applied to the treated surface, the carrier film being wound upon itself with the adhesive contacting the release surface;
unwinding the carrier film with the adhesive releasing from the release surface;
laminating a graphics film to the carrier film, the graphics film including a coextruded layer of heat activated adhesive facing away from the carrier film;
cutting graphics in the graphics film;
weeding excess material from the graphics film; and
hot pressing the graphics onto the fabric substrate;
wherein the adhesive comprises acrylic and isocyanate in a ratio of isocyanate to acrylic of at least about 1.1%.

26. The method of applying heat activated graphics of claim 25, further comprising:
removing the carrier film from the graphics and leaving the graphics on the fabric substrate, while the carrier film is still hot.

27. The method of applying heat activated graphics of claim 25, further comprising:
allowing the carrier film and graphics to cool; and
removing the carrier film from the graphics and leaving the graphics on the fabric substrate.
